(19) United States
(12) Patent Application Publication
(10) Pub. No.: US 2005/0205222 A1
(43) Pub. Date: Sep. 22, 2005

(54) Low-clearance shutter slat

(76) Inventor: James V. Miller, Glen Ellyn, IL (US)

Correspondence Address: ICE MILLER, ONE AMERICAN SQUARE, BOX 82001, INDIANAPOLIS, IN, 46282, US

(21) Appl. No.: 10/802,385

(22) Filed: Mar. 17, 2004

(51) Int. Cl. E06B 9/15

(52) U.S. Cl. 160/236

(57) ABSTRACT

A rolling shutter and a slat for use in a rolling shutter are provided. The slat comprises an engaging track located at a first horizontal edge and a receptacle track located at a second horizontal edge. Illustratively, the engaging track has a hook-shaped profile and is disposed at an acute angle, and the receptacle track comprises a lip and a guard defining a space adapted to receive therein an engaging track of an adjacent slat.

### BACKGROUND OF THE INVENTION

1. Field of the Invention

The present invention relates to shutters and in particular to shutters of the roller type having improved resistance to storms and break-ins. It furthermore relates to a shutter having improved retraction capability.

2. Description of the Related Art

Conventional roller shutters are designed to provide security from break-ins or protection from storms. Because such protection and security may not always be necessary or desired, such as during the day when a retail store is open for business, or during fine weather when a homeowner wishes to open windows or enjoy an ocean view, roller shutters are designed to be retractable into a casing in which they are stored. To facilitate compact storage, rigid shutter slats designed to resist hurricane winds and burglars must be capable of conforming to a roll.

One conventional shutter slat is made to conform to a roll by providing a loose articulation between slats. Slats are slidably engaged at the upper edge of one slat and the lower edge of another slat. The upper edge comprises a vertical projection terminating in a hook-shaped profile. The lower edge comprises a first portion and a second portion, which define a vertical pocket. The hook-shaped profile of the upper edge allows the upper edge to engage the first portion of the lower edge, also having a hook-shaped profile. The upper edge is prevented from undesirably disengaging by the second portion of the lower edge, which comprises a guard extending downward to slightly below the hook-shaped profile of the lower edge, defining a horizontal aperture between the first and second portions of the lower edge. The vertical pocket defined by the first and second portions of the lower edge is similar in depth to the height of the vertical projection of the upper edge. This shutter configuration's flexibility arises from the pivoting of the vertical portion of the upper edge within the horizontal aperture.

One result of this configuration is that the upper edge has significant vertical clearance within the vertical pocket. For a shutter according to this configuration, a clearance of one-quarter inch per slat would be expected. A shutter having 48 slats would then have a total clearance of twelve inches. To raise such a shutter, a user must lift the bottom slat either by hand or mechanically to correct for the full amount of clearance before the shutter will begin to retract. In the case of a conventional shutter having 48 slats with one-quarter inch of clearance per slat, a user would have to lift approximately 150 pounds by twelve inches in order to engage the shutter's retraction mechanism.

A further result of this configuration is that the loosely articulated slats are known to be noisy. The slats rattle against each other during extension and retraction. In addition, when the roller shutter is deployed, the normal forces of the wind are sufficient to cause the slats to rattle audibly.

A second conventional solution to the problem of compact storage includes integration of a boss concentric with the articulation between adjoining slats, as described in U.S. Pat. No. 6,095,225 to Miller, titled “Shutter Slat with Integrated Boss.” Slats in this configuration are also slidably engaged at the upper edge of one slat and the lower edge of another slat. The upper edge comprises a short vertical projection terminating in a c-shaped screw boss, and the lower edge comprises a c-shaped channel having a diameter sufficient to accommodate the upper edge. This shutter configuration's flexibility arises from the cooperation of the rounded internal surface of the c-shaped channel and the rounded external surface of the c-shaped screw boss. The diameter of the upper edge is smaller than the diameter of the c-shaped channel, but greater than the width of the aperture defined by the c-shaped channel, preventing the upper edge from simply falling out of the c-shaped channel provided by the lower edge.

One result of this configuration is that if the exposed portion of the c-shaped channel of the lower edge gives way upon exertion of pressure on the articulation, the slats may separate undesirably. Because the retention of the upper edge by the c-shaped channel is based on a relatively small difference in size, damage to either edge may result in a breach of the curtain. For example, if a putative intruder uses a sledgehammer to dent or bend a shutter, the c-shaped channel may be forced open. Even if the channel is bent only slightly, once a gap is formed between an upper edge and a lower edge, the two slats may be pried apart with undesirably slight effort.

A further result of this configuration is that in use of a concentric retention screw, the normal collection of dirt and grime around the screw may impede the flexibility of the articulation between slats.

### OBJECTS OF THE INVENTION

It is an object of the present invention to improve the ease and smoothness of extension and retraction of the roller shutter.

It is another object of the invention to provide a stable, secure connection between slats of the roller shutter and between the roller shutter and the guides, thereby improving the security and protection provided by the roller shutter.

It is a further object of the invention to reduce the noise associated with extension and retraction of the roller shutter, as well as the noise associated with a deployed roller shutter.

### SUMMARY OF THE INVENTION

According to the present invention, smooth extension and retraction of the roller shutter may be achieved with significantly less effort than required by prior art devices by minimizing the clearance between the engaging track of one shutter slat and the receptacle track of the adjacent shutter slat. There is thus provided a shutter for a building aperture comprising a plurality of shutter slats each having a first face and a second face, and a first end and a second end, and an upper and a lower horizontal edge, which are articulated to form a roller shutter having a first face and a second face, and a first end and a second end. Each shutter slat further has an engaging track and a receptacle track, which run along opposing horizontal edges of each shutter slat. The shutter further comprises two guides, with one guide locatable at either end of the roller shutter.

Advantageously, clearance between engaging and receptacle tracks may be decreased by the alteration of the angle of the engaging track relative to the vertical axis of the shutter curtain. The present invention provides for the engaging track to be disposed at an acute angle to the vertical axis of an upright shutter slat. In contrast to prior art shutter slats, the angled engaging track of the present invention allows shutter slats to pivot freely while remaining securely disposed within the receptacle track.

According to another aspect of the invention, the stability of the connection between engaging track and receptacle track is further improved by providing a guard along the receptacle track. Use of the guard provides protection for the lip and engaging track against damage inflicted on the first face of the roller shutter, such as by a storm or an intruder. Additionally, the security of the roller shutter within the guides is improved by the provision of a boss for a retention screw above the main pocket of the receptacle track rather than concentrically with the articulation. The retention screw, which is used to slidably mount each shutter slat on the first and second guides, is therefore shielded from external forces, including attempts to compromise the integrity of an articulation by forcing two shutter slats apart. The combination of the boss and the guard as provided in the present invention improves stability and security over the use of a concentric boss by increasing the force needed to separate an articulation between slats or separate the roller shutter from a guide.

In yet another aspect of the present invention, the complementary curved profiles of the engaging and receptacle tracks combined with the reduced clearance between shutter slats will minimize the noise associated with operation and use of the roller shutter. If, as the engaging track pivots within the receptacle track, the convex interior of the engaging track contacts the concave interior of the receptacle track, the former will slide against the latter. In contrast to a loosely articulated shutter slat, the engaging track of the present invention has no flat (vertical) surfaces to rattle or clank between the first and second portions of the receptacle track. Furthermore, by configuring the receptacle track to receive a retention screw that is not concentric with the engaging track, the ordinary collection of dirt and grime around the retention screw will not cause squeaking between slats or impede the flexibility of the articulation between slats.

### BRIEF DESCRIPTION OF THE DRAWINGS

Embodiments of the invention will now be explained in further detail by way of example only with reference to the accompanying figures, in which:

FIG. 1 is a side view of a low-clearance shutter slat according to the present invention;

FIG. 2 is a detailed side view of a receptacle track according to the present invention;

FIG. 3 is a detailed side view of an engaging track according to the present invention;

FIG. 4 is an elevation of a window aperture including a shutter according to the present invention;

FIG. 5 is an elevation of a shutter slat according to the present invention;

FIG. 6 is a side view of the cooperation of two shutter slats according to the present invention;

FIG. 7 is a partial horizontal sectional view according to the present invention.

### DETAILED DESCRIPTION

FIG. 5 depicts an elevation of a low-clearance shutter slat according to the present invention. Shutter slat 1 is an elongated body of single-ply extruded aluminum having a first end 15 and a second end 16, a body portion 30 bounded by an upper edge 23 and a lower edge 24, and an engaging track 4 and a receptacle track 5.

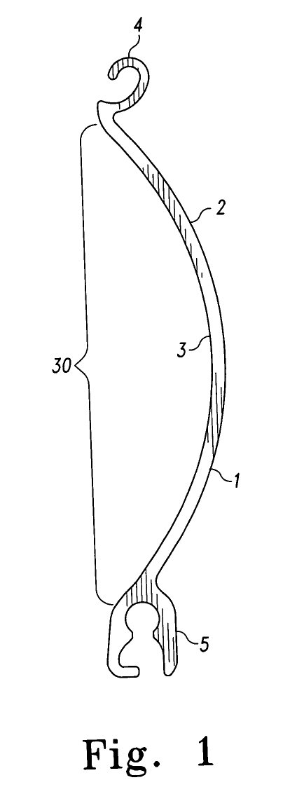

FIG. 1 is a side view of a low-clearance shutter slat according to the present invention. FIG. 1 depicts a first side 2 of shutter slat 1 and a second side 3, the body portion 30, and the profile of engaging track 4 and receptacle track 5.

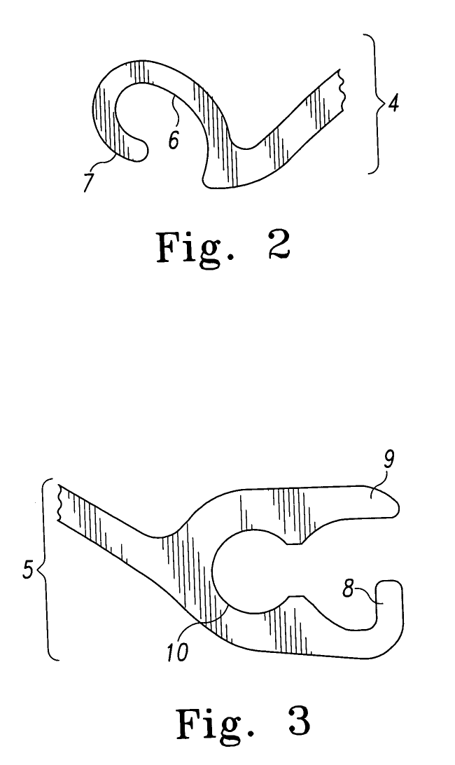

A detail of engaging track 4 is shown in FIG. 2. Engaging track 4, located at upper edge 23 of shutter slat 1, comprises a track running the length of shutter slat 1 having a hook-shaped profile. Engaging track 4 further comprises an inner surface 6 and an outer surface 7. Engaging track 4 is disposed at an acute angle to the vertical axis of an upright shutter slat. It is to be understood that engaging track 4 could, in the alternate, be located at lower edge 24.

FIG. 3 depicts a detail of receptacle track 5, located at lower edge 24. Receptacle track 5 comprises a track running the length of shutter slat 1. Receptacle track 5 further comprises a lip 8, a guard 9, and a boss 10. When the slat 1 is in a vertical position, boss 10 is located above the aperture defined by lip 8 and guard 9. Boss 10 is adapted to receive retention screw 22 (not shown). It is to be understood that receptacle track 5 could, in the alternate, be located at upper edge 23 but in any case the boss 10 would be located between the body portion of the shutter slat 1 and the aperture defined by lip 8 and guard 9.

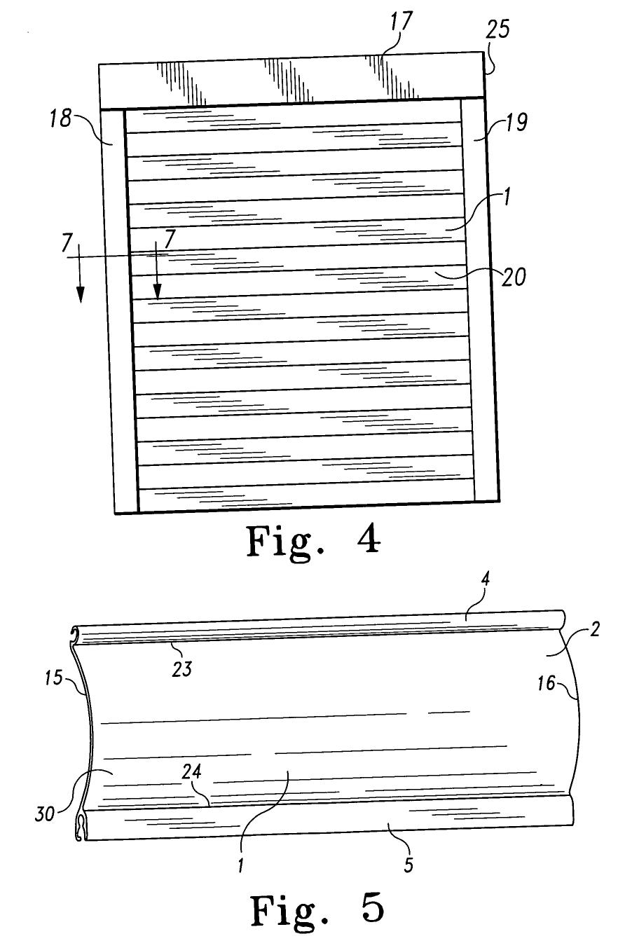

FIG. 4 shows an elevation of a plurality of shutter slats 1 according to the present invention, articulated into a roller shutter 20 which may be installed on a building aperture 25 such as a window or door. Details of building aperture 25 are not illustrated for the sake of clarity. Building aperture 25 is further equipped with a shutter casing 17 and a pair of guides 18 and 19, located on opposite lateral edges of building aperture 25. Roller shutter 20 may be rolled up for storage within shutter casing 17.

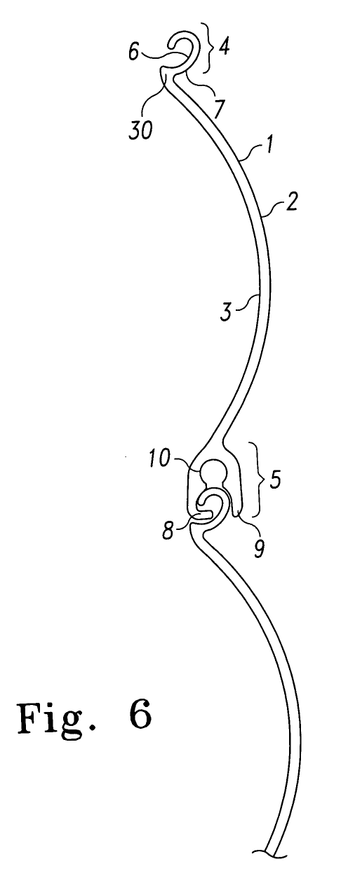

FIG. 6 is a side view of the articulation of two shutter slats 1 according to the present invention. Engaging track 4 is slidably engaged within receptacle track 5 of the adjacent shutter slat 1. Inner surface 6 rests against lip 8. Guard 9 shields the connection of engaging track 4 with lip 10, preventing engaging track 4 from undesirably disengaging from receptacle track 5. Guard 9 also protects the engaging track 4 and lip 10 from exposure to forces applied to the first side 2 of shutter slat 1. Because engaging track 4 does not bear directly upon guard 9, damage to first side 2 including to guard 9 is less likely to disengage the articulation between shutter slats 1 than in prior art shutters in which an exposed portion of a lower track was weight-bearing.

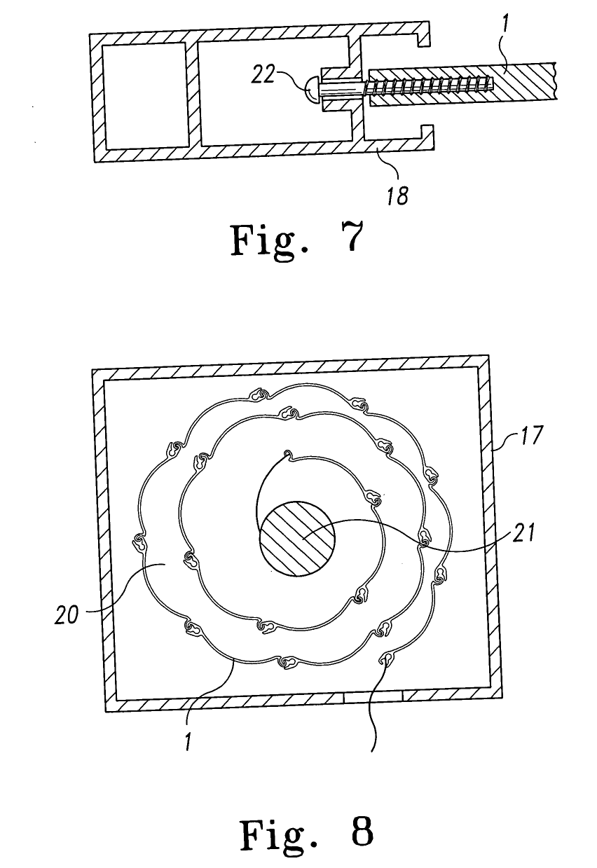

FIG. 7 is a partial sectional view according to the present invention. A shutter slat 1 is shown in combination with a guard 18 and a retention screw 22. A retention screw 22 is preferably inserted in boss 11 (not shown) of shutter slat 1 for use with a guide 18, 19. The head of the retention screw 22 protrudes from boss 11 and slides within a vertical guide 18, 19 provided at each end of the roller shutter 20. In this invention, the retention screw 22 does not restrict the rotation or pivoting of engaging track 4 within receptacle track 5. It is also preferred, for minimization of the rolled shutter, that the diameter of the head of the retention screw 22 is not larger than the external profile of the receptacle track 5.

In contrast to prior art systems that require significant clearance at the articulation in order to allow pivoting, the angled engaging track 4 of the present invention allows shutter slat 1 to pivot freely within receptacle track 5.

The resulting flexibility of the roller shutter 20 allows the roller shutter 20 to be rolled up at a favorably compact size into shutter casing 17.

Modifications in addition to those described above may be made to the structures and techniques described herein without departing from the spirit and scope of the invention. Accordingly, although specific embodiments have been described, these are examples only and are not limiting on the scope of the invention.

1. A slat for use in a rolling shutter, comprising:
a body portion;
a first face and a second face;
a first end and a second end;
an upper edge and a lower edge (a first and a second horizontal edge);
an engaging track wherein said engaging track is locatable at said upper edge (first horizontal edge) and runs the length of said slat;
a receptacle track, wherein said receptacle track is locatable at said lower edge (second horizontal edge) and runs the length of said slat;
wherein said engaging track comprises a track having a hook shaped profile and is disposed at an acute angle to the vertical axis of said slat;
wherein said receptacle track comprises a lip and a guard and is adapted to receive said engaging track;
whereby said slat may be articulated to a second, identical slat by slidably engaging the receptacle track of one slat with the engaging track of the second slat.

2. A slat as in claim 1 wherein said engaging track is disposed at an angle of between XX and XX to the vertical axis of said slat.

3. A slat as in claim 5, wherein said lip and said guard define an aperture similar in shape and size to said engaging track, whereby clearance between said engaging track and said receptacle track is minimized.

4. A slat as in claim 1, wherein said receptacle track further comprises a boss.

5. A slat as in claim 5, wherein said lip and said guard define an aperture running the length of said slat; and wherein said boss is locatable within said receptacle track, between said body portion and said aperture.

6. A slat as in claim 6, wherein said boss is adapted to receive a retention screw.

7. A shutter slat according to claim 1, wherein a plurality of said slats are articulated to form a roller shutter, wherein said roller shutter further comprises one or more guides, and a shutter casing.
